(19) United States
(12) Patent Application Publication
(10) Pub. No.: US 2022/0229963 A1
(43) Pub. Date: Jul. 21, 2022

(54) PROGRAM, METHOD AND APPARATUS FOR PRINTED SUBSTRATE DESIGN PROGRAM

(71) Applicant: FUJITSU LIMITED, Kawasaki-shi (JP)

(72) Inventor: Shinichi NAKAMOTO, Tachikawa (JP)

(73) Assignee: FUJITSU LIMITED, Kawasaki-shi (JP)

(21) Appl. No.: 17/502,193

(22) Filed: Oct. 15, 2021

(30) Foreign Application Priority Data
Jan. 20, 2021 (JP) 2021-6816

(51) Int. Cl. G06F 30/39; H05K 3/00

(52) U.S. Cl. CPC G06F 30/39; G06F 2119/06; H05K 3/0005

(57) ABSTRACT

A first design information of a first printed substrate and a second printed substrate coupled to the first printed substrate via power supply terminals or ground terminals is obtained. Then, first regions are obtained by dividing a region where a power supply wiring layer or a ground wiring layer is formed along a direction in which a power supply current or a ground current flows. Then, second regions are obtained by dividing the plurality of first regions by a plurality of equipotential lines, and a target resistance value of each of the plurality of second regions is calculated based on a target voltage drop between adjacent equipotential lines and a target current value set for each of the power supply terminals or the ground terminals. Then, second design information of the power supply wiring layer or the ground wiring layer is generated based on the target resistance value.

### CROSS-REFERENCE TO RELATED APPLICATION

This application is based upon and claims the benefit of priority of the prior Japanese Patent Application No. 2021-6816, filed on Jan. 20, 2021, the entire contents of which are incorporated herein by reference.

### FIELD

The embodiments discussed herein are related to a computer-readable recording medium storing a printed substrate design program, a printed substrate design method, and a printed substrate design apparatus.

### BACKGROUND

There is a case where another printed substrate on which a large scale integrated (LSI) circuit is mounted is coupled to a printed substrate via a plurality of power supply terminals and a plurality of ground terminals. In recent years, a terminal size has been miniaturized due to a high density of these terminals. For this reason, a current density in a solder joint portion for coupling the terminals to each other and in a via in the printed substrate increases, and a fracture of the solder joint portion or the via due to electromigration is likely to occur.

Due to a difference in a resistance value of a path from a current supply source (for example, a direct current (DC)-DC converter) to a current supply destination (for example, an LSI), a current is locally concentrated on, among the plurality of power supply terminals and the plurality of ground terminals, one that is close to the current supply source and the current supply destination. Since the current density is particularly high in such a solder joint portion or a via coupled to the power supply terminal or the ground terminal, electromigration is promoted and a fracture is likely to occur.

In the related art, in order to suppress the current from concentrating on a specific power supply terminal, there is a method of adjusting a resistance value in a current path by providing an opening or the like in a power supply wiring layer or increasing the number of power supply wiring layers.

There is a method of adjusting a resistance value by changing a diameter of a via coupled to a power supply terminal in order to suppress an excessive current from flowing through the power supply terminal. There is a technique that makes it possible to obtain a resistance value and a resistance distribution in an electrode pattern by potential analysis even when the electrode pattern has a complicated shape. In a process of designing an antenna coil, there has been a method of dividing a space where an antenna to be designed is disposed into a plurality of meshes and calculating an optimum current amount of each mesh. Japanese Laid-open Patent Publication Nos. 2019-129261, 2019-129262, 2018-107307, 7-63799, and 2020-35028 are disclosed as related art.

### SUMMARY

According to an aspect of the embodiments, a printed substrate design method performed by a computer, the method including, acquiring first design information of a first printed substrate and a second printed substrate coupled to the first printed substrate via a plurality of power supply terminals or a plurality of ground terminals, for each of the first printed substrate and the second printed substrate, determining, based on the first design information, a plurality of first regions obtained by dividing a region where a power supply wiring layer or a ground wiring layer is formed along a direction in which a power supply current or a ground current flows, determined from positions of a plurality of supply sources and a plurality of supply destinations of the power supply current or the ground current; determining a plurality of second regions obtained by dividing the plurality of first regions by a plurality of equipotential lines; calculating a target resistance value of each of the plurality of second regions based on a target voltage drop value set between adjacent equipotential lines in the plurality of equipotential lines and a target current value set for each of the plurality of power supply terminals or the plurality of ground terminals, and generating second design information of the power supply wiring layer or the ground wiring layer based on the target resistance value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a printed substrate design method and a printed substrate design apparatus according to a first embodiment;

FIG. 2 is a block diagram illustrating a hardware example of the printed substrate design apparatus;

FIG. 3 is a block diagram illustrating a function example of the printed substrate design apparatus;

FIG. 4 is a flowchart illustrating an example of a processing procedure of the printed substrate design apparatus;

FIG. 5 is a flowchart illustrating an example of a procedure of region division processing;

FIG. 6 is a flowchart illustrating an example of a procedure of detailed design processing;

FIG. 7 is a schematic cross-sectional view of two printed substrates to be designed in a first design example;

FIG. 8 is a schematic top view of the two printed substrates to be designed in the first design example;

FIG. 9 is a diagram illustrating a determination example of a current direction in a lower printed substrate;

FIG. 10 is a diagram illustrating a determination example of a current direction in an upper printed substrate;

FIG. 11 is a diagram illustrating a determination example of a first region in the lower printed substrate;

FIG. 12 is a diagram illustrating a determination example of a first region in the upper printed substrate;

FIG. 13 is a diagram illustrating a determination example of a second region and a setting example of a target voltage drop value in the lower printed substrate;

FIG. 14 is a diagram illustrating a determination example of a second region and a setting example of a target voltage drop value in the upper printed substrate;

FIG. 15 is a diagram illustrating a setting example of a target current value and a calculation example of a current value in each second region in the lower printed substrate;

FIG. 16 is a diagram illustrating a calculation example of a current value in each second region in the upper printed substrate;

FIG. 17 is a schematic top view of two printed substrates after the determination of the second region;

FIG. 18 is a diagram illustrating a calculation example of a target resistance value and an example of detailed design;

FIG. 19 is a diagram illustrating an effect obtained when a target resistance value is obtained by detailed design;

FIG. 20 is a schematic cross-sectional view of two printed substrates to be designed in a first design example;

FIG. 21 is a schematic top view of two printed substrates to be designed in a second design example;

FIG. 22 is a diagram illustrating a determination example of a current direction in the lower printed substrate;

FIG. 23 is a diagram illustrating a determination example of a current direction in the upper printed substrate;

FIG. 24 is a diagram illustrating a determination example of a first region in the lower printed substrate;

FIG. 25 is a diagram illustrating a determination example of a first region in the upper printed substrate;

FIG. 26 is a diagram illustrating a determination example of a second region and a setting example of a target voltage drop value in the lower printed substrate; and

FIG. 27 is a diagram illustrating a determination example of a second region and a setting example of a target voltage drop value in the upper printed substrate.

### DESCRIPTION OF EMBODIMENTS

In a method of the related art for adjusting resistance in a current path by providing an opening or the like in a power supply wiring layer or increasing the number of power supply wiring layers, redesign of a power supply wiring layer or a ground wiring layer is repeated until a degree of uniformity of currents that flow through a plurality of power supply terminals or a plurality of ground terminals falls within an allowable range. For example, when the degree of uniformity is out of the allowable range, a design change is made such that the resistance value increases at a portion where the current is large and the resistance value decreases at a portion where the current is small. Therefore, there has been a problem that it takes time to design a power supply wiring layer or a ground wiring layer capable of suppressing current concentration.

In one aspect, an object of the present disclosure is to provide a printed substrate design program, a printed substrate design method, and a printed substrate design apparatus capable of shortening a design time of a power supply wiring layer or a ground wiring layer capable of suppressing current concentration.

Hereinafter, embodiments of the present disclosure will be described with reference to the drawings.

### First Embodiment

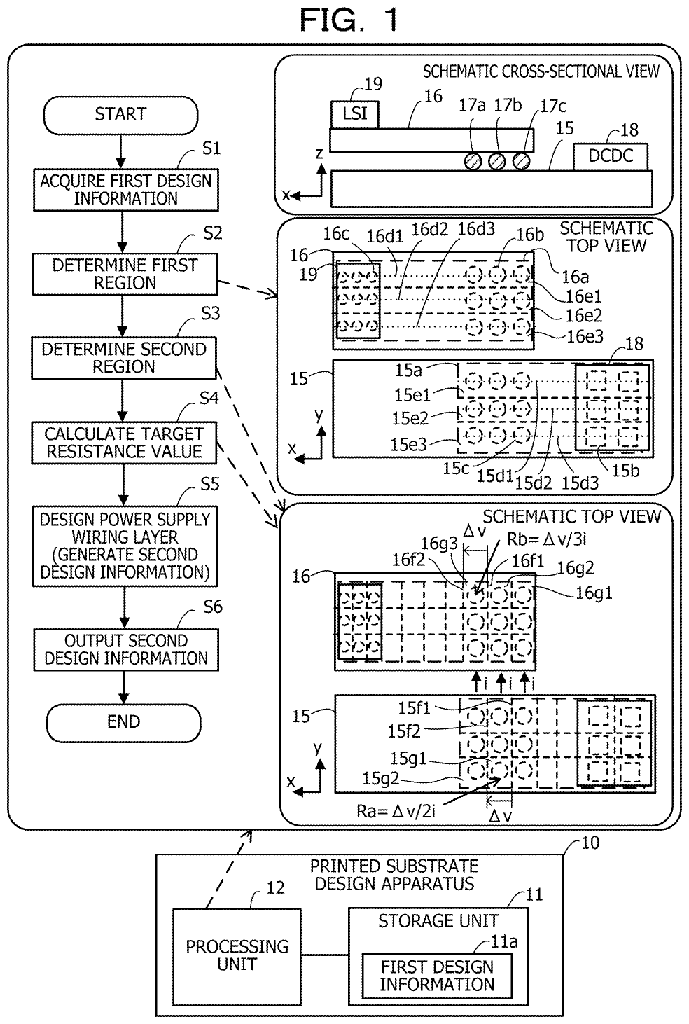

FIG. 1 is a diagram illustrating an example of a printed substrate design method and a printed substrate design apparatus according to a first embodiment.

The printed substrate design apparatus 10 according to the first embodiment designs a plurality of printed substrates coupled via a plurality of power supply terminals or a plurality of ground terminals.

The printed substrate design apparatus 10 includes a storage unit 11 and a processing unit 12.

The storage unit 11 is a volatile storage device such as a random-access memory (RAM) or a non-volatile storage device such as a hard disk drive (HDD) and a flash memory.

The storage unit 11 stores design information (hereafter, referred to as first design information 11a) of a plurality of printed substrates coupled via a plurality of power supply terminals or a plurality of ground terminals.

The first design information 11a is, for example, computer aided design (CAD) data that includes information on an arrangement, a shape, and physical property values (such as resistivity) of a power supply wiring layer, a ground wiring layer, a via, a plurality of power supply terminals, a plurality of ground terminals, and the like included in each of the plurality of printed substrates. The first design information 11a may include information on an arrangement, a shape, and the like of a signal wiring layer, a plurality of signal terminals, and the like, or information on a device to be mounted (current consumption of the LSI, allowable voltage drop value, and the like). Information on a power supply wiring layer or a ground wiring layer included in the first design information 11a is obtained by basic design, and information on a configuration for avoiding current concentration on a power supply terminal or the like is generated by detailed design described later.

The printed substrate design apparatus 10 may receive an input by a user and create the first design information 11a based on the input, and the printed substrate design apparatus 10 may acquire the first design information 11a generated in another information processing apparatus.

The processing unit 12 is realized by a processor that is hardware such as a central processing unit (CPU) and a digital signal processor (DSP). However, the processing unit 12 may include an electronic circuit such as an application-specific integrated circuit (ASIC) and a field-programmable gate array (FPGA). The processor executes a program stored in a memory such as a RAM. For example, a printed substrate design program is executed. A set of a plurality of processors may be referred to as a “multiprocessor” or simply a “processor”.

Based on the first design information 11a, the processing unit 12 designs, in each of the plurality of printed substrates, a power supply wiring layer and a ground wiring layer in which a resistance value of each region is adjusted such that a current does not concentrate on a specific power supply terminal or a ground terminal. In the following example, a design method of two printed substrates will be described, but the method may be similarly applied to three or more printed substrates.

FIG. 1 illustrates examples of printed substrates 15 and 16 to be designed. The printed substrates 15 and 16 are coupled via a plurality of power supply terminals or a plurality of ground terminals. In the example of FIG. 1, a plurality of power supply terminals (not illustrated) in each of the printed substrates 15 and 16 are coupled via solder bumps (solder bumps 17a, 17b, 17c, and the like in the schematic cross-sectional view of FIG. 1). A DC-DC converter 18 (denoted as DCDC in FIG. 1) is mounted on the printed substrate 15, and an LSI 19 is mounted on the printed substrate 16.

An example of a procedure for designing the power supply wiring layers of the printed substrates 15 and 16 as illustrated in FIG. 1 will be described below.

When the processing unit 12 acquires the first design information 11a from the storage unit 11 (step S1), the processing unit 12 performs the following processing on each of the printed substrates 15 and 16.

First, based on the first design information 11a, the processing unit 12 determines a plurality of first regions obtained by dividing a region where a power supply wiring layer is formed along a direction in which a power supply current flows, determined from positions of a plurality of supply sources and a plurality of supply destinations of the power supply current (step S2).

In the example of FIG. 1, in the schematic top view of the printed substrates 15 and 16 related to the processing of step S2, a region 15a in the printed substrate 15 in which the power supply wiring layer is formed and a region 16a in the printed substrate 16 in which the power supply wiring layer is formed are illustrated.

A plurality of via coupling portions (such as via coupling portions 15b and 15c) are provided in the region 15a. A plurality of via coupling portions (such as the via coupling portions 15b) located below the DC-DC converter 18 are portions to which a plurality of vias through which a power supply current supplied from the DC-DC converter 18 flows are coupled in the power supply wiring layer of the printed substrate 15. A plurality of via coupling portions (such as the via coupling portions 15c) located below the plurality of power supply terminals coupled to the printed substrate 16 are portions to which a plurality of vias through which a power supply current supplied to the printed substrate 16 flows are coupled in the power supply wiring layer of the printed substrate 15.

A plurality of via coupling portions (such as via coupling portions 16b and 16c) are also provided in the region 16a. The plurality of via coupling portions (such as the via coupling portions 16b) located above the plurality of power supply terminals coupled to the printed substrate 15 are portions to which a plurality of vias through which a power supply current supplied from the printed substrate 15 flows are coupled in the power supply wiring layer of the printed substrate 16. A plurality of via coupling portions (such as the via coupling portions 16c) located below the LSI 19 are portions to which a plurality of vias through which a power supply current supplied to the LSI 19 flows are coupled in the power supply wiring layer of the printed substrate 16.

Therefore, in the region 15a, the plurality of via coupling portions located below the DC-DC converter 18 serve as supply sources of the power supply current, and the plurality of via coupling portions located below the plurality of power supply terminals coupled to the printed substrate 16 serve as supply destinations of the power supply current. In the region 16a, the plurality of via coupling portions located above the plurality of power supply terminals coupled to the printed substrate 15 serve as supply sources of the power supply current, and the plurality of via coupling portions located below the LSI 19 serve as supply destinations (may also be referred to as consumption destinations) of the power supply current.

For this reason, in the processing of Step S2, first, in each of the regions 15a and 16a, the processing unit 12 determines a direction in which the power supply current flows, based on the positions of the plurality of via coupling portions that are the plurality of supply sources of the power supply current and the positions of the plurality of via coupling portions that are the plurality of supply destinations of the power supply current. The direction in which the power supply current flows may be a direction of a straight line that passes through the via coupling portion of the supply source of the power supply current and a via coupling portion of the supply destination of the power supply current located at the shortest distance with respect to the via coupling portion.

As illustrated in FIG. 1, the processing unit 12 generates straight lines 15d1, 15d2, and 15d3 as described above for the via coupling portions of the respective supply sources of the power supply current in the region 15a. For example, the straight line 15d3 is a straight line that passes through the via coupling portion 15b of the supply source of the power supply current and the via coupling portion 15c of the supply destination of the power supply current located at the shortest distance to the via coupling portion 15b. As illustrated in FIG. 1, the processing unit 12 generates straight lines 16d1, 16d2, and 16d3 as described above for the via coupling portions of the respective supply sources of the power supply current in the region 16a. For example, the straight line 16d3 is a straight line that passes through the via coupling portion 16b of the supply source of the power supply current and the via coupling portion 16c of the supply destination of the power supply current located at the shortest distance to the via coupling portion 16b.

As illustrated in FIG. 1, when the widths (lengths in a y-axis direction) of a region where a plurality of supply sources of the power supply current are provided, a region where a plurality of supply destinations of the power supply current are provided, and the regions 15a and 16a where the power supply wiring layers are formed are approximately the same, any determined straight line is a straight line that extends in an x-axis direction. Therefore, the processing unit 12 divides the regions 15a and 16a into a plurality of first regions along the x-axis direction. In order to facilitate the calculation, the processing unit 12 performs the division such that the respective supply sources or the respective supply destinations of the power supply current does not straddle the plurality of first regions.

FIG. 1 illustrates first regions 15e1, 15e2, 15e3, 16e1, 16e2, and 16e3 obtained by dividing the regions 15a and 16a between the respective straight lines generated as described above. In order to simplify the calculation, it is assumed that there is no inflow or outflow of the power supply current between each of the first regions 15e1, 15e2, 15e3, 16e1, 16e2, and 16e3.

After the processing of step S2, the processing unit 12 determines a plurality of second regions obtained by dividing the plurality of first regions by a plurality of equipotential lines (step S3). FIG. 1 illustrates an example of a plurality of second regions (such as second regions 15g1, 15g2, 16g1, 16g2, and 16g3) obtained by dividing a plurality of first regions by the plurality of equipotential lines (such as equipotential lines 15f1, 15f2, 16f1, and 16f2). In the example of FIG. 1, since the direction in which the power supply current flows is the x-axis direction, the equipotential lines are straight lines that extend in the y-axis direction.

Although an amount of calculation is increased by finely setting the equipotential lines, a calculation accuracy is increased.

After the processing of step S3, the processing unit 12 calculates a target resistance value for each of the plurality of second regions based on a target voltage drop value set between adjacent equipotential lines in the plurality of equipotential lines and a target current value set in each of the plurality of power supply terminals (step S4). The target current value is, for example, the same value for each of the plurality of power supply terminals. The target current values set for the respective power supply terminals do not have to be the same value as long as current concentration may be suppressed, and may be different values within an allowable range.

The target voltage drop value is set, for example, from an allowable voltage drop value of the LSI 19 or the like. The target voltage drop values between the respective equipotential lines may not be the same.

The target current value is set based on, for example, the current consumption of the LSI 19 or the like. For example, the processing unit 12 calculates the target current value by dividing the current consumption of the LSI 19 by the number of power supply terminals to which the printed substrates 15 and 16 are coupled.

FIG. 1 illustrates calculation examples of the target resistance values of the second regions 15g1 and 16g3.

In the second region 15g1, a current having a value obtained by summing a value of a power supply current that flows from the via coupling portion included in the second region 15g1 to the power supply terminal via a via and a value of the power supply current that flows from the via coupling portion included in the second region 15g2 on a downstream side in a current direction to the power supply terminal via a via flows. When the target current values set for the respective power supply terminals are defined as i, a current of 2i flows in the second region 15g1. When the target voltage drop value set between the equipotential lines 15f1 and 15f2 at both ends of the second region 15g1 is defined as Δv, the target resistance value of the second region 15g1 is Ra=Δv/2i.

In the second region 16g3, a current having a total value of the power supply currents supplied from the power supply terminals to the via coupling portions included in the second regions 16g1 to 16g3 flows via the vias. When the target current value set for the respective power supply terminals are defined as i, a current of 3i flows in the second region 16g3. When the target voltage drop value set between the equipotential lines 16f1 and 16f2 at both ends of the second region 16g3 is defined as Δv, the target resistance value of the second region 16g3 is Rb=Δv/3i.

After that, the processing unit 12 generates second design information obtained by designing the power supply wiring layer based on the calculated target resistance value (step S5). Based on the calculated target resistance value, the processing unit 12 performs design (detailed design) such that each second region has a target resistance value (or a difference from the target resistance value is within an allowable range) by decreasing the resistance by increasing the number of power supply wiring layers or increasing the resistance by providing one or a plurality of openings in the power supply wiring layers.

The processing unit 12 outputs the generated second design information (step S6), and ends the processing. For example, the processing unit 12 may output the second design information to a display device (not illustrated) to be displayed, or may output the second design information to the storage unit 11 to be stored. The processing unit 12 may transmit the second design information to an information processing apparatus outside the printed substrate design apparatus 10 via a network.

The above-described processing procedure is an example. For example, the processing unit 12 may first set the plurality of equipotential lines, then determine the plurality of first regions, divide the determined plurality of first regions by the plurality of equipotential lines, and determine the plurality of second regions.

According to the printed substrate design method of the first embodiment as described above, the target resistance value of each of the plurality of second regions obtained by dividing the power supply wiring layer is calculated based on the target current value or the target voltage drop value set for each power supply terminal. Since the target resistance value of each second region of the power supply wiring layer in which current concentration on the power supply terminal is suppressed is obtained before the detailed design, repetition of the detailed design may be suppressed, and the design time may be shortened.

In the above example, the design of the power supply wiring layer has been described, but the present embodiment may be similarly applied to a ground wiring layer.

For example, based on the first design information 11a, the processing unit 12 determines a plurality of first regions obtained by dividing a region where a ground wiring layer is formed along a direction in which a ground current flows, determined from the positions of a plurality of supply sources and a plurality of supply destinations of the ground current. The processing unit 12 determines a plurality of second regions obtained by dividing the plurality of first regions by a plurality of equipotential lines. After that, the processing unit 12 calculates a target resistance value of each of the plurality of second regions based on the target voltage drop value set between the adjacent equipotential lines in the plurality of equipotential lines and the target current value set for each of the plurality of ground terminals. Based on the target resistance value, the processing unit 12 generates second design information obtained by designing the ground wiring layer. Thus, the same effect as described above is obtained.

### Second Embodiment

Next, a second embodiment will be described.

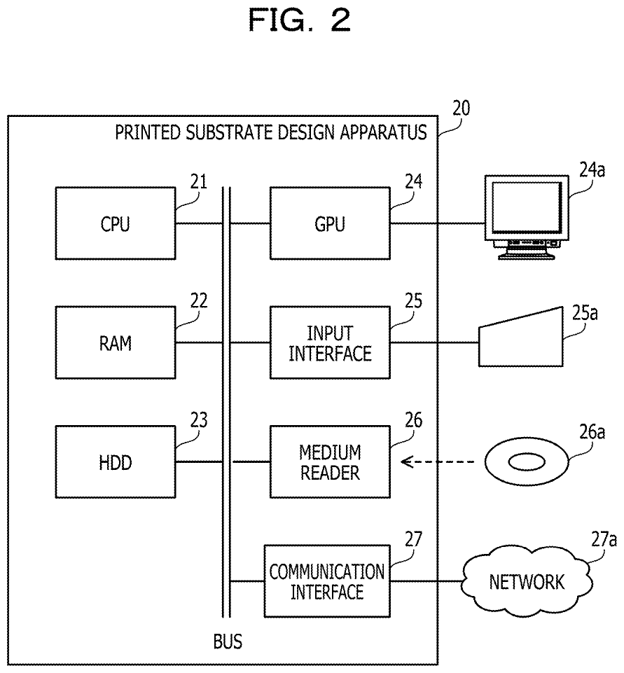

FIG. 2 is a block diagram illustrating a hardware example of the printed substrate design apparatus.

A printed substrate design apparatus 20 may be realized by a computer as illustrated in FIG. 2. The printed substrate design apparatus 20 includes a CPU 21, a RAM 22, an HDD 23, a graphics processing unit (GPU) 24, an input interface 25, a medium reader 26, and a communication interface 27. The above-described units are coupled to a bus.

The CPU 21 is a processor that includes an arithmetic circuit that executes program commands. The CPU 21 loads at least a part of a program and data stored in the HDD 23 into the RAM 22 and executes the program. The CPU 21 may include a plurality of processor cores, the printed substrate design apparatus 20 may include a plurality of processors, and processing described below may be executed in parallel by using a plurality of processors or processor cores. A set of a plurality of processors (multiprocessor) may be referred to as a “processor”.

The RAM 22 is a volatile semiconductor memory that temporarily stores a program executed by the CPU 21 or data used for computation by the CPU 21. The printed substrate design apparatus 20 may include a type of memory other than the RAM, and may include a plurality of memories.

The HDD 23 is a non-volatile storage device that stores a software program such as an operating system (OS), middleware, and application software, and data. The program includes, for example, a printed substrate design program that causes the printed substrate design apparatus 20 to execute printed substrate design processing. The printed substrate design apparatus 20 may include other types of storage devices such as a flash memory and a solid-state drive (SSD), and may include a plurality of non-volatile storage devices.

The GPU 24 outputs an image to a display 24a coupled to the printed substrate design apparatus 20 in accordance with a command from the CPU 21. As the display 24a, a cathode ray tube (CRT) display, a liquid crystal display (LCD), a plasma display panel (PDP), an organic electro-luminescence (OEL) display, or the like may be used.

The input interface 25 acquires an input signal from an input device 25a coupled to the printed substrate design apparatus 20 and outputs the input signal to the CPU 21. As the input device 25a, a pointing device such as a mouse, a touch panel, a touchpad, and a trackball, a keyboard, a remote controller, a button switch, or the like may be used. A plurality of types of input devices may be coupled to the printed substrate design apparatus 20.

The medium reader 26 is a reading device that reads a program or data recorded on a recording medium 26a. As the recording medium 26a, for example, a magnetic disk, an optical disk, a magneto-optical (MO) disk, a semiconductor memory, or the like may be used. The magnetic disk includes a flexible disk (FD) or an HDD. The optical disk includes a compact disc (CD) or a Digital Versatile Disc (DVD).

For example, the medium reader 26 copies a program or data read from the recording medium 26a to another recording medium such as the RAM 22 and the HDD 23. For example, the read program is executed by the CPU 21. The recording medium 26a may be a portable recording medium, and may be used to distribute a program or data. The recording medium 26a or the HDD 23 may be referred to as a computer-readable recording medium.

The communication interface 27 is an interface that is coupled to a network 27a and that communicates with another information processing apparatus via the network 27a. The communication interface 27 may be a wired communication interface coupled to a communication device such as a switch via a cable, or may be a wireless communication interface coupled to a base station via a wireless link.

Next, a function and a processing procedure of the printed substrate design apparatus 20 will be described.

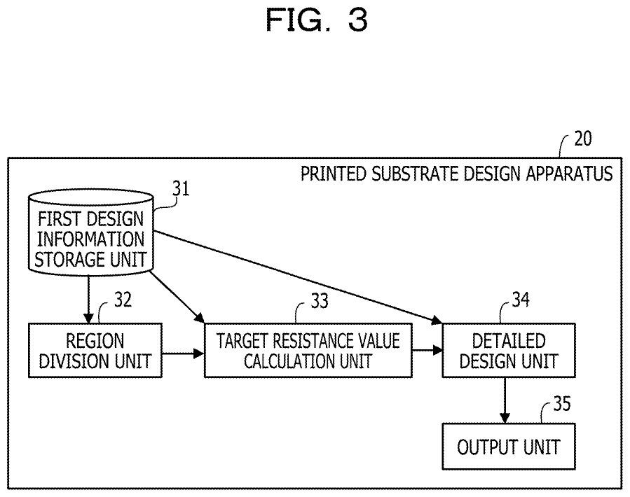

FIG. 3 is a block diagram illustrating a function example of the printed substrate design apparatus.

The printed substrate design apparatus 20 has a first design information storage unit 31, a region division unit 32, a target resistance value calculation unit 33, a detailed design unit 34, and an output unit 35. The first design information storage unit 31 may be implemented by using, for example, a storage area secured in the RAM 22 or the HDD 23. The region division unit 32, the target resistance value calculation unit 33, the detailed design unit 34, and the output unit 35 may be implemented by using, for example, a program module executed by the CPU 21.

The first design information storage unit 31 stores the first design information 11a described above.

The region division unit 32 divides a region where a power supply wiring layer or a ground wiring layer of two printed substrates is formed into a plurality of regions (a plurality of second regions in the example of FIG. 1 described above).

The target resistance value calculation unit 33 calculates a target resistance value in each of the plurality of regions.

The detailed design unit 34 performs detailed design of the power supply wiring layer or the ground wiring layer based on the calculated target resistance value.

The output unit 35 outputs design information obtained by the detailed design.

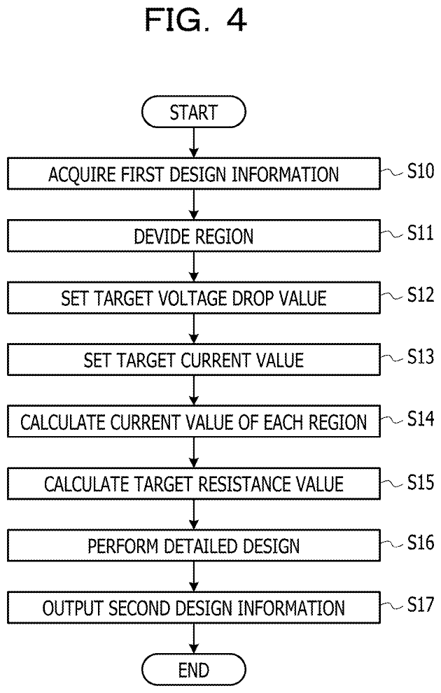

FIG. 4 is a flowchart illustrating an example of a processing procedure of the printed substrate design apparatus.

The region division unit 32 acquires the first design information 11a from the first design information storage unit 31 (step S10), and divides the region where the power supply wiring layer or the ground wiring layer of each of the plurality of printed substrates is formed into a plurality of regions based on the first design information 11a (step S11). Details of the processing procedure of Step S11 will be described later.

Next, the target resistance value calculation unit 33 sets a target voltage drop value between adjacent equipotential lines among the plurality of equipotential lines set at the time of the region division in the processing of step S11 (step S12).

The target resistance value calculation unit 33 sets a target current value for each of a plurality of power supply terminals or a plurality of ground terminals that couple the printed substrates (step S13), and calculates a current value for each of the plurality of regions (step S14).

The target resistance value calculation unit 33 calculates a target resistance value of each of the plurality of regions based on the target voltage drop value and the current value of each region (step S15).

The detailed design unit 34 designs (detailed design) the power supply wiring layer or the ground wiring layer based on the target resistance value (step S16). Details of the processing procedure of Step S16 will be described later.

Thereafter, the output unit 35 outputs design information (second design information) obtained by the detailed design (step S17). For example, the output unit 35 may output the second design information to the display 24a to be displayed or may output the second design information to the HDD 23 to be stored. The output unit 35 may transmit the second design information to an information processing apparatus outside the printed substrate design apparatus 20 via the network 27a.

The above-described processing procedure is an example, and an order of processing may be changed as appropriate.

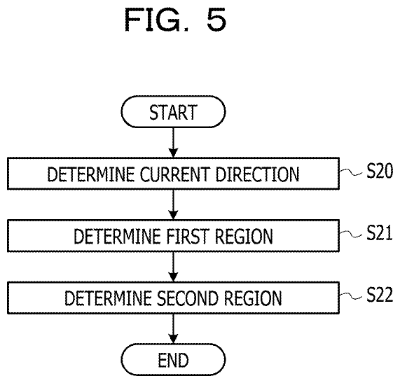

FIG. 5 is a flowchart illustrating an example of a procedure of region division processing.

The region division unit 32 determines a current direction in the power supply wiring layer or the ground wiring layer of each printed substrate based on the first design information 11a (step S20). The current direction is determined from the positions of a plurality of supply sources and a plurality of supply destinations of the power supply current in the power supply wiring layer, and determined from the positions of a plurality of supply sources and a plurality of supply destinations of the ground current in the ground wiring layer.

The current direction may be, for example, a direction of a straight line that passes through the via coupling portion of the supply source of the power supply current or the ground current and a via coupling portion of the supply destination of the power supply current or the ground current located at the shortest distance with respect to the via coupling portion. Therefore, the region division unit 32 generates the above-described straight line for each of the plurality of via coupling portions of the supply sources of the power supply current or the ground current. For example, when the power supply wiring layer or the ground wiring layer has a complicated shape, the region division unit 32 may determine the current direction by simulation based on the positions of the plurality of supply sources and the plurality of supply destinations.

The region division unit 32 determines a plurality of first regions obtained by dividing the region where the power supply wiring layer or the ground wiring layer is formed along the determined direction in which the power supply current flows (step S21). The region division unit 32 determines the plurality of first regions such that respective boundaries of the plurality of first regions do not straddle each of the plurality of straight lines generated as described above as much as possible. The region division unit 32 determines, for example, the plurality of first regions by dividing, a region where a power supply wiring layer or a ground wiring layer is formed in the middle of adjacent straight lines among the plurality of straight lines generated as described above.

The region division unit 32 sets a plurality of equipotential lines, divides each of the plurality of first regions by the plurality of equipotential lines to determine a plurality of second regions (step S22), and ends the region division processing.

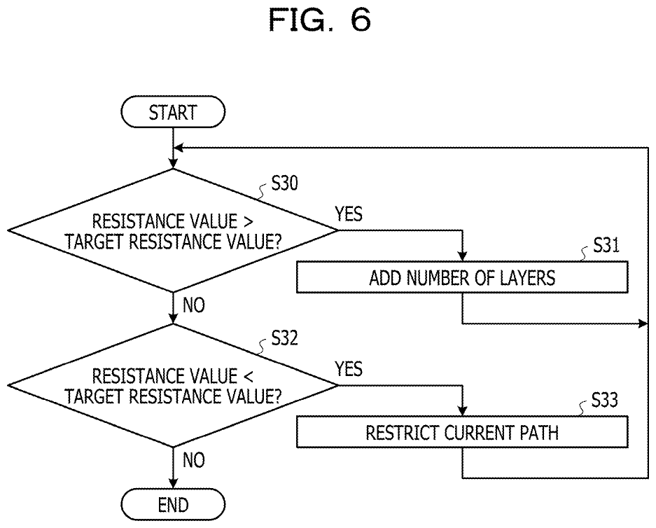

FIG. 6 is a flowchart illustrating an example of a procedure of detailed design processing.

The detailed design unit 34 calculates a resistance value of each of the plurality of second regions based on the first design information 11a, and determines whether the resistance value of each second region is larger than the target resistance value calculated for the second region (step S30).

When the detailed design unit 34 determines that there is a second region having a resistance value larger than the target resistance value, the detailed design unit 34 adds the number of layers in the region that includes the second region in the power supply wiring layer or the ground wiring layer (step S31). Thus, the resistance value of the second region may be decreased to approach the target resistance value. After the processing of step S31, processing from step S30 is repeated.

When the detailed design unit 34 determines that there is no second region having a resistance value larger than the target resistance value, the detailed design unit 34 determines whether the resistance value of each second region is smaller than the target resistance value calculated for the second region (step S32).

When the detailed design unit 34 determines that there is a second region having a resistance value smaller than the target resistance value, the detailed design unit 34 restricts a current path by providing one or a plurality of openings in the second region of the power supply wiring layer or the ground wiring layer (step S33). Thus, the resistance value of the second region may be increased to approach the target resistance value. After the processing of step S33, the processing from step S30 is repeated.

When the detailed design unit 34 determines that there is no second region having a resistance value smaller than the target resistance value, the detailed design unit 34 ends the detailed design processing.

In the above-described processing example, when the resistance value of each second region matches the target resistance value, the detailed design ends. However, when a difference between the resistance value and the target resistance value of each second region is within a predetermined allowable range, the detailed design may end.

Hereinafter, two design examples using the printed substrate design method as described above are described.

(First Design Example)

In the first design example, two printed substrates substantially similar to the printed substrates 15 and 16 illustrated in FIG. 1 are set as design targets.

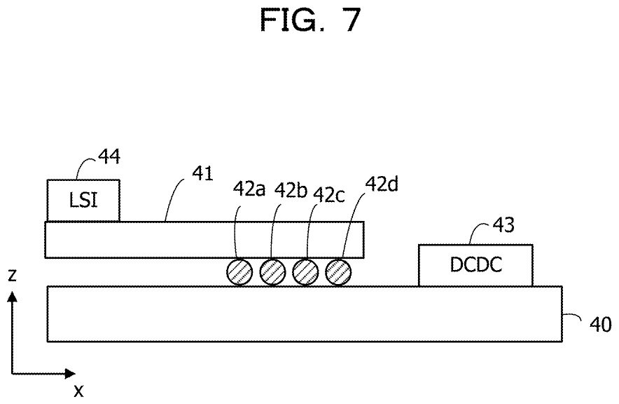

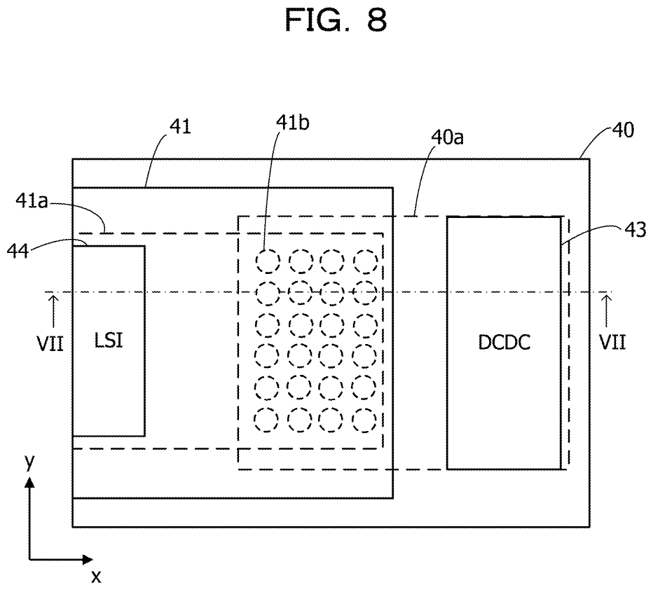

FIG. 7 is a schematic cross-sectional view of the two printed substrates to be designed in the first design example. FIG. 8 is a schematic top view of the two printed substrates to be designed in the first design example. FIG. 7 illustrates a cross section taken along line VII-VII in FIG. 8.

Printed substrates 40 and 41 are coupled via a plurality of power supply terminals or a plurality of ground terminals. In the example of FIG. 7, a plurality of power supply terminals (not illustrated) in each of the printed substrates 40 and 41 are coupled via solder bumps (solder bumps 42a, 42b, 42c, 42d, and the like). A DC-DC converter 43 is mounted on the printed substrate 40, and an LSI 44 is mounted on the printed substrate 41.

FIG. 8 illustrates a region 40a in the printed substrate 40 where a power supply wiring layer is formed and a region 41a in the printed substrate 41 where a power supply wiring layer is formed.

A plurality of via coupling portions are provided in the regions 40a and 41a. For example, via coupling portions 41b provided in the region 41a of the upper printed substrate 41 are electrically coupled to via coupling portions in the region 40a of the lower printed substrate 40 via power supply terminals and vias.

When designing the printed substrates 40 and 41 as described above, the region division unit 32 determines a current direction, for example, as follows in the processing of step S20 in FIG. 5 described above.

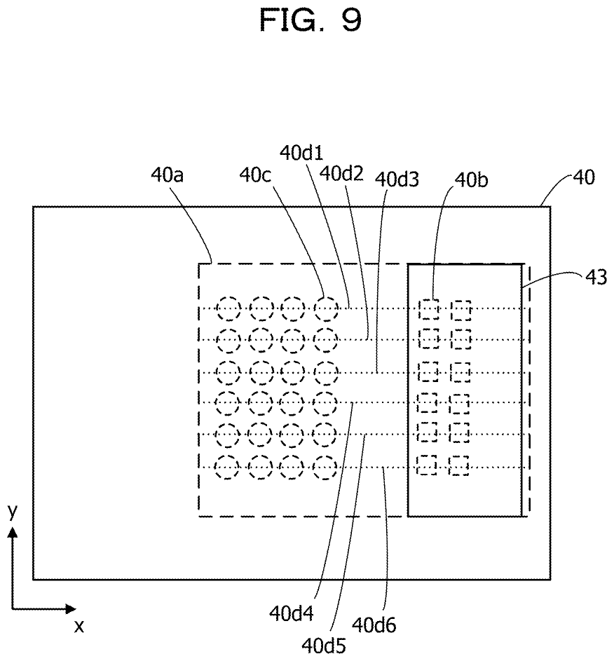

FIG. 9 is a diagram illustrating a determination example of a current direction in the lower printed substrate.

In the region 40a of the lower printed substrate 40, a plurality of via coupling portions (such as via coupling portions 40b) that are located below the DC-DC converter 43 and serve as current supply sources are provided. In the region 40a, a plurality of via coupling portions (such as via coupling portions 40c) that are located below the plurality of power supply terminals coupled to the printed substrate 41 and serve as current supply destinations are provided.

In the region 40a, the region division unit 32 generates straight lines 40d1, 40d2, 40d3, 40d4, 40d5, and 40d6 that pass through each via coupling portion of the supply source of the power supply current and a via coupling portion of the supply destination of the power supply current located at the shortest distance with respect to the via coupling portion. For example, the straight line 40d1 is a straight line that passes through the via coupling portion 40b of the supply source of the power supply current and the via coupling portion 40c of the supply destination of the power supply current located at the shortest distance to the via coupling portion 40b. The region division unit 32 determines a direction of the straight lines 40d1 to 40d6 in the region 40a as a current direction.

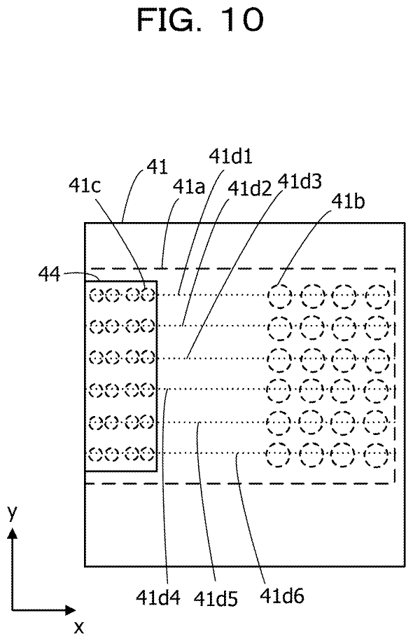

FIG. 10 is a diagram illustrating a determination example of a current direction in the upper printed substrate.

In the region 41a of the upper printed substrate 41, a plurality of via coupling portions (such as via coupling portions 41b) that are located above the plurality of power supply terminals coupled to the printed substrate 40 and serve as current supply sources are provided. In the region 41a, a plurality of via coupling portions (such as via coupling portions 41c) that are located below the LSI 44 and serve as current supply destinations are provided.

In the region 41a, the region division unit 32 generates straight lines 41d1, 41d2, 41d3, 41d4, 41d5, and 41d6 that pass through each via coupling portion of the supply source of the power supply current and a via coupling portion of the supply destination of the power supply current located at the shortest distance with respect to the via coupling portion. For example, the straight line 41d1 is a straight line that passes through the via coupling portion 41b of the supply source of the power supply current and the via coupling portion 41c of the supply destination of the power supply current located at the shortest distance to the via coupling portion 41b. The region division unit 32 determines a direction of the straight lines 41d1 to 41d6 in the region 41a as a current direction.

Next, the region division unit 32 determines a first region, for example, as follows in the processing of step S21 in FIG. 5 described above.

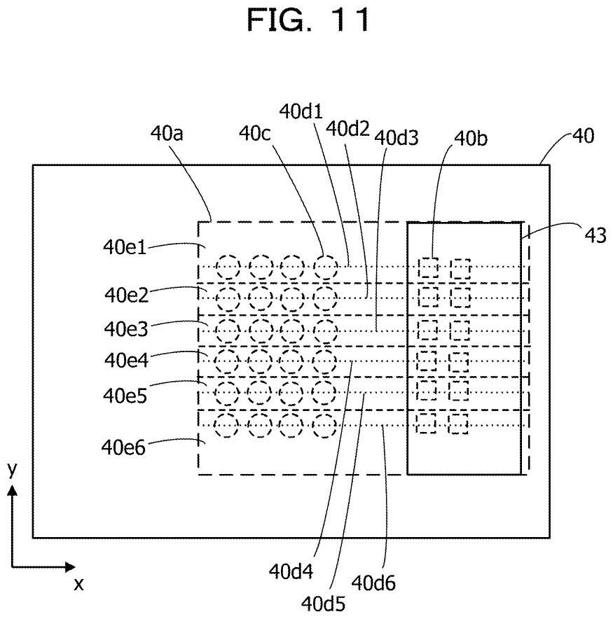

FIG. 11 is a diagram illustrating a determination example of a first region in the lower printed substrate.

The region division unit 32 determines a plurality of first regions 40e1, 40e2, 40e3, 40e4, 40e5, and 40e6 as illustrated in FIG. 11 by dividing the region 40a of the printed substrate 40 in the x-axis direction in the middle of adjacent straight lines among the straight lines 40d1 to 40d6.

In order to simplify the calculation, it is assumed that there is no inflow or outflow of the power supply current between each of the first regions 40e1 to 40e6.

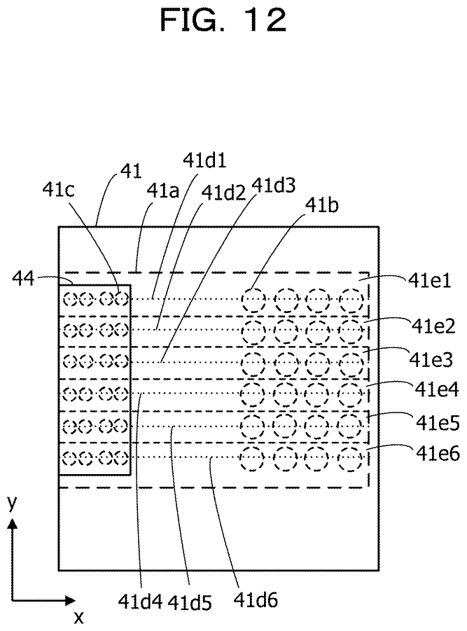

FIG. 12 is a diagram illustrating a determination example of a first region in the upper printed substrate.

The region division unit 32 determines a plurality of first regions 41e1, 41e2, 41e3, 41e4, 41e5, and 41e6 as illustrated in FIG. 12 by dividing the region 41a of the printed substrate 41 in the x-axis direction in the middle of adjacent straight lines among the straight lines 41d1 to 41d6.

In order to simplify the calculation, it is assumed that there is no inflow or outflow of the power supply current between each of the first regions 41e1 to 41e6.

Next, the region division unit 32 determines the second region in the processing of step S22 in FIG. 5 described above, for example, as follows. The target resistance value calculation unit 33 sets the target voltage drop value in the processing of step S12 in FIG. 4 described above, for example, as follows.

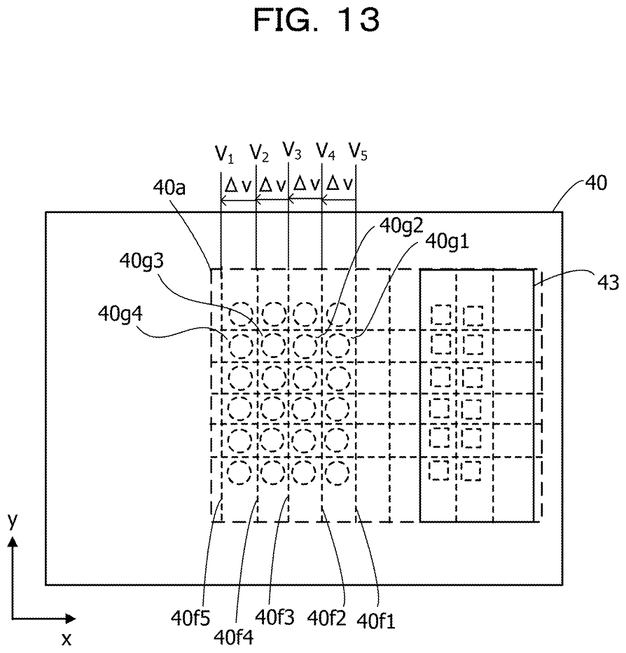

FIG. 13 is a diagram illustrating a determination example of a second region and a setting example of a target voltage drop value in the lower printed substrate.

The region division unit 32 sets a plurality of equipotential lines (such as equipotential lines 40f1, 40f2, 40f3, 40f4, and 40f5) in the region 40a of the printed substrate 40, and divides the first regions 40e1 to 40e6 illustrated in FIG. 11 in the y-axis direction. Thus, a plurality of second regions (such as second regions 40g1, 40g2, 40g3, and 40g4) are determined.

After that, the target resistance value calculation unit 33 sets a target voltage drop value between adjacent equipotential lines in the set plurality of equipotential lines. In the example of FIG. 13, it is targeted that a voltage drop from a voltage V₅ to a voltage V₁ occurs between the equipotential line 40f1 to the equipotential line 40f5, and the same target voltage drop value of Δv is set between the adjacent equipotential lines.

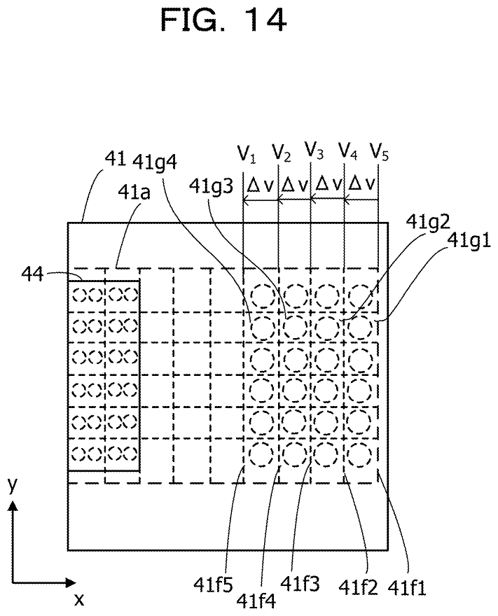

FIG. 14 is a diagram illustrating a determination example of a second region and a setting example of a target voltage drop value in the upper printed substrate.

The region division unit 32 sets a plurality of equipotential lines (such as equipotential lines 41f1, 41f2, 41f3, 41f4, and 41f5) in the region 41a of the printed substrate 41, and divides the first regions 41e1 to 41e6 illustrated in FIG. 12 in the y-axis direction. Thus, a plurality of second regions (such as second regions 41g1, 41g2, 41g3, and 41g4) are determined.

After that, the target resistance value calculation unit 33 sets a target voltage drop value between adjacent equipotential lines in the set plurality of equipotential lines. In the example of FIG. 14, it is targeted that a voltage drop from a voltage V₅ to a voltage V₁ occurs between the equipotential line 41f1 to the equipotential line 41f5, and the same target voltage drop value of Δv is set between the adjacent equipotential lines.

After that, in the processing of steps S13 and S14 in FIG. 4, the target resistance value calculation unit 33 sets the target current value and calculates current values of the respective second regions, for example, as follows.

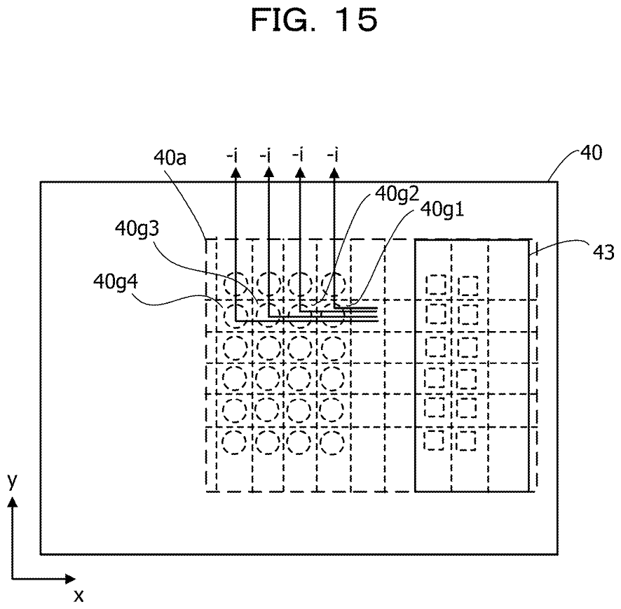

FIG. 15 is a diagram illustrating a setting example of the target current value and a calculation example of a current value in each second region in the lower printed substrate.

The target resistance value calculation unit 33 sets the same target current value for each of the plurality of power supply terminals that couple the printed substrates 40 and 41. The target current value is, for example, obtained by dividing the current consumption of the LSI 44 by the number of power supply terminals that couple the printed substrates 40 and 41.

The target resistance value calculation unit 33 calculates a current value in each second region based on the target current value. As described above, since it is assumed that there is no inflow or outflow of the power supply current between each of the plurality of first regions, the target resistance value calculation unit 33 performs calculation on the assumption that there is no inflow or outflow of the power supply current between the second regions adjacent in a y direction, in each second region.

When the target current value=i is set as the value of the power supply current that flows through each of the plurality of power supply terminals, for example, the power supply current with the target current value=i is drawn from each of the second regions 40g1 to 40g4 including one via coupling portion respectively. Therefore, it is denoted as “−i” in FIG. 15.

The current value in the second region 40g4 is calculated as i because the power supply current with the target current value=i is drawn from the second region 40g4. The current value in the second region 40g3 is calculated as 2i by adding the power supply current (current value=i) supplied to the second region 40g4 on the upstream side and the target current value=i to be drawn. The current value in the second region 40g2 is calculated as 3i by adding the power supply current (current value=2i) supplied to the second region 40g3 on the upstream side and the target current value=i to be drawn. The current value in the second region 40g1 is calculated as 4i by adding the power supply current (current value=3i) supplied to the second region 40g2 on the upstream side and the target current value=i to be drawn.

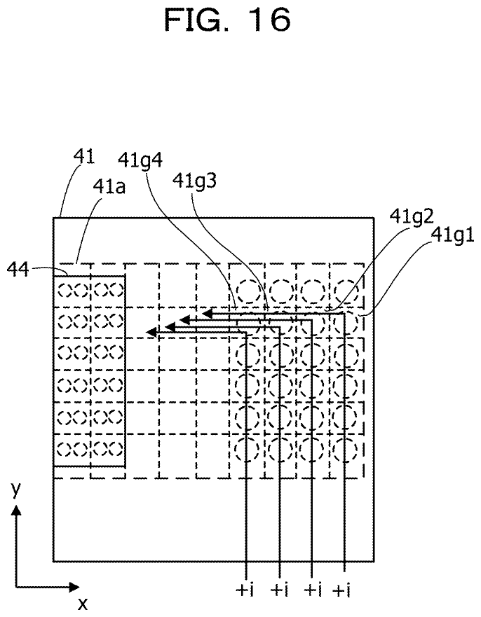

FIG. 16 is a diagram illustrating a calculation example of a current value of each second region in the upper printed substrate.

As described above, since it is assumed that there is no inflow or outflow of the power supply current between each of the plurality of first regions, the target resistance value calculation unit 33 performs calculation on the assumption that there is no inflow or outflow of the power supply current between the second regions adjacent in the y direction, in each second region.

When the target current value=i is set as the value of the power supply current that flows through each of the plurality of power supply terminals, for example, the power supply current with the target current value=i is supplied from the printed substrate 40 to each of the second regions 41g1 to 41g4 including one via coupling portion respectively. Therefore, it is denoted as “+i” in FIG. 16.

The current value in the second region 41g1 is calculated as i because the power supply current with the target current value=i is supplied from the second region 40g1 in FIG. 15. The current value in the second region 41g2 is calculated as 2i by adding the power supply current (current value=i) supplied from the second region 41g1 on the downstream side and the power supply current (target current value=i) supplied from the second region 40g2 in FIG. 15. The current value in the second region 41g3 is calculated as 3i by adding the power supply current (current value=2i) supplied from the second region 41g2 on the downstream side and the power supply current (target current value=i) supplied from the second region 40g3 in FIG. 15. The current value in the second region 41g4 is calculated as 4i by adding the power supply current (current value=3i) supplied from the second region 41g3 on the downstream side and the power supply current (target current value=i) supplied from the second region 40g3 in FIG. 15.

Next, the target resistance value calculation unit 33 calculates a target resistance value in the processing of step S15 in FIG. 4, for example, as follows, and the detailed design unit 34 performs detailed design in the processing of step S16 in FIG. 4, for example, as follows.

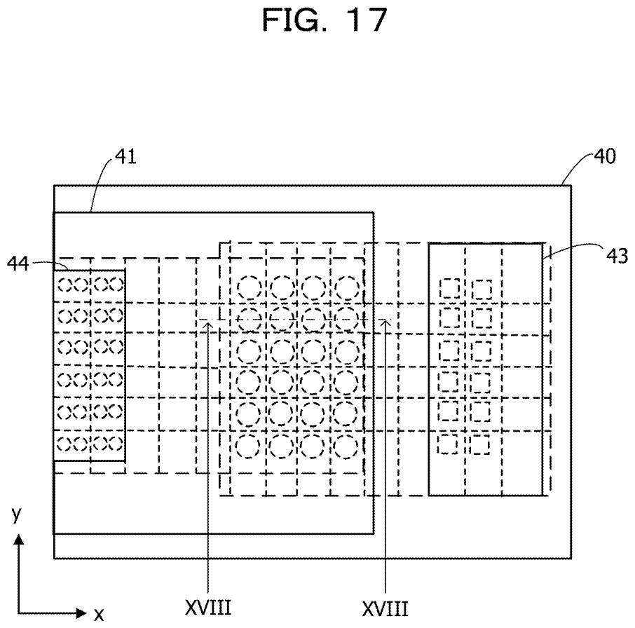

FIG. 17 is a schematic top view of the two printed substrates after the determination of the second region. A calculation example of a target resistance value and an example of detailed design will be described below with reference to a cross section taken along line XVIII-XVIII in FIG. 17.

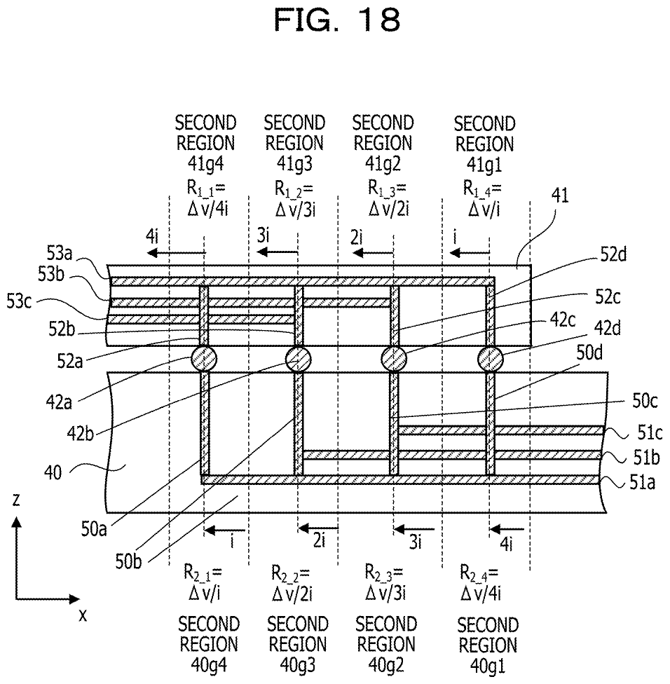

FIG. 18 is a diagram illustrating a calculation example of a target resistance value and an example of detailed design.

In FIG. 18, R_{2_1} is a target resistance value of the second region 40g4 in FIG. 15, R_{2_2} is a target resistance value of the second region 40g3 in FIG. 15, R_{2_3} is a target resistance value of the second region 40g2 in FIG. 15, and R_{2_4} is a target resistance value of the second region 40g1 in FIG. 15. In FIG. 18, R_{1_1} is a target resistance value of the second region 41g4 in FIG. 16, R_{1_2} is a target resistance value of the second region 41g3 in FIG. 16, R_{1_3} is a target resistance value of the second region 41g2 in FIG. 16, and R_{1_4} is a target resistance value of the second region 41g1 in FIG. 16.

In the printed substrate 40, as described above, since the current value in the second region 40g4 is i and the target voltage drop value is Δv, R_{2_1}=Δv/i is calculated, and since the current value in the second region 40g3 is 2i and the target voltage drop value is Δv, R_{2_2}=Δv/2i is calculated. As described above, since the current value in the second region 40g2 is 3i and the target voltage drop value is Δv, R_{2_3}=Δv/3i is calculated, and since the current value in the second region 40g1 is 4i and the target voltage drop value is Δv, R_{2_4}=Δv/4i is calculated.

In the printed substrate 41, as described above, since the current value in the second region 41g4 is 4i and the target voltage drop value is Δv, R_{1_1}=Δv/4i is calculated, and since the current value in the second region 41g3 is 3i and the target voltage drop value is Δv, R_{1_2}=Δv/3i is calculated. As described above, since the current value in the second region 41g2 is 2i and the target voltage drop value is Δv, R_{1_3}=Δv/2i is calculated, and since the current value in the second region 41g1 is i and the target voltage drop value is Δv, R_{1_4}=Δv/i is calculated.

The detailed design unit 34 performs detailed design as illustrated in FIG. 18, for example, in order to realize the target resistance value determined as described above.

In the printed substrate 40, a via 50a coupled to a via coupling portion of the second region 40g4 is coupled to a power supply wiring layer 51a, and a via 50b coupled to a via coupling portion of the second region 40g3 is coupled to power supply wiring layers 51a and 51b. In the printed substrate 40, a via 50c coupled to a via coupling portion of the second region 40g2 is coupled to the power supply wiring layers 51a, 51b, and 51c, and a via 50d coupled to a via coupling portion of the second region 40g1 is also coupled to the power supply wiring layers 51a, 51b, and 51c.

In the printed substrate 41, a via 52a coupled to a via coupling portion of the second region 41g4 is coupled to power supply wiring layers 53a, 53b, and 53c, and a via 52b coupled to a via coupling portion of the second region 41g3 is also coupled to the power supply wiring layers 53a, 53b, and 53c. In the printed substrate 41, a via 52c coupled to a via coupling portion of the second region 41g2 is coupled to the power supply wiring layers 53a and 53b, and a via 52d coupled to a via coupling portion of the second region 41g1 is coupled to the power supply wiring layer 53a.

By changing the number of power supply wiring layers in each of the second regions in this manner, the resistance value may approach the target resistance value. For example, in a place where the resistance value is desired to be ½, the number of power supply wiring layers may be doubled.

As illustrated in FIG. 6, the resistance value in the second region may approach the target resistance value by providing an opening in the power supply wiring layer to restrict the current path. For example, in a place where the resistance value is desired to be tripled, the resistance value may be tripled by arranging an opening in a direction that obstructs the power supply current and reducing the width of the current path to ⅓.

When it is difficult to achieve the target resistance value by the above-described method, the number of power supply terminals may be changed to change the number of via coupling portions included in the first region. However, when the direction in which the power supply current flows is changed due to the change, it is desirable to perform the region division again.

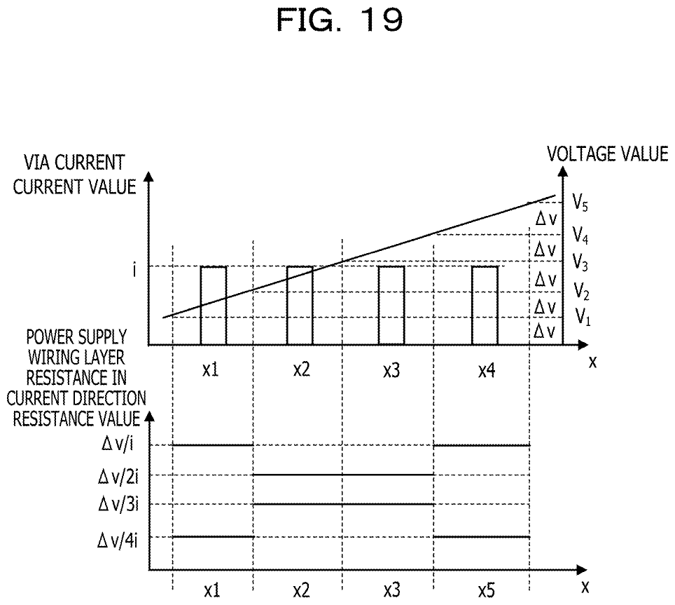

FIG. 19 is a diagram illustrating an effect obtained when a target resistance value is obtained by detailed design. FIG. 19 illustrates power supply currents (via current) that flow through the vias 50a, 50b, 50c, 50d, 52a, 52b, 52c, and 52d illustrated in FIG. 18. FIG. 19 illustrates a state of a voltage drop in the second regions 40g1 to 40g4 and 41g1 to 40g4. FIG. 19 illustrates resistance values (resistance in the current direction in the power supply wiring layer) of the second regions 40g1 to 40g4 and 41g1 to 41g4.

A horizontal axis indicates the second regions 40g1 to 40g4 and 41g1 to 41g4 arranged in the x-axis direction in FIG. 18 and the like. x1 represents the second regions 40g4 and 41g4, x2 represents the second regions 40g3 and 41g3, x3 represents the second regions 40g2 and 41g2, and x4 represents the second regions 40g1 and 41g1. A vertical axis represents a current value and a voltage value of a via current in a graph of a via current and a voltage drop, and represents a resistance value in a graph of resistance in the current direction in the power supply wiring layer.

As illustrated in FIG. 19, when the target resistance value is obtained by the detailed design, the power supply currents that flow through the vias 50a, 50b, 50c, 50d, 52a, 52b, 52c, and 52d may be equalized, and current concentration on the power supply terminal may be suppressed. The voltage drop in the second regions 40g1 to 40g4 and 41g1 to 41g4 may be set to Av, which is the set target voltage drop value.

According to the printed substrate design method as described above, since the target resistance value of each second region of the power supply wiring layer in which current concentration on the power supply terminal is suppressed may be obtained before the detailed design, repetition of the detailed design may be suppressed, and the design time may be shortened.

(Second Design Example)

The second design example assumes a case where a plurality of power supply terminals that couple two printed substrates are provided in a wider range than the plurality of power supply terminals of the DC-DC converter or the plurality of power supply terminals of the LSI to be mounted. For example, the present design example may be applied when there are many power supply terminals that couple two printed substrates in order to consume a large current.

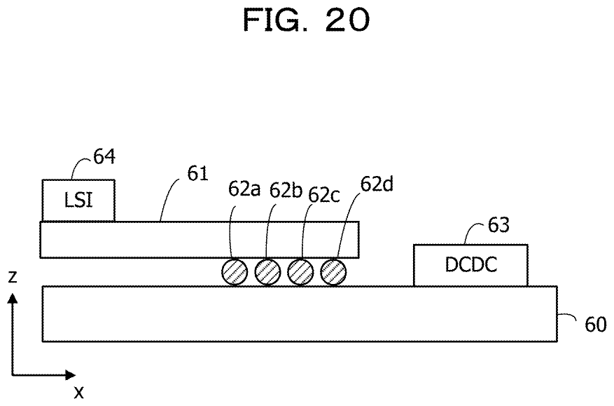

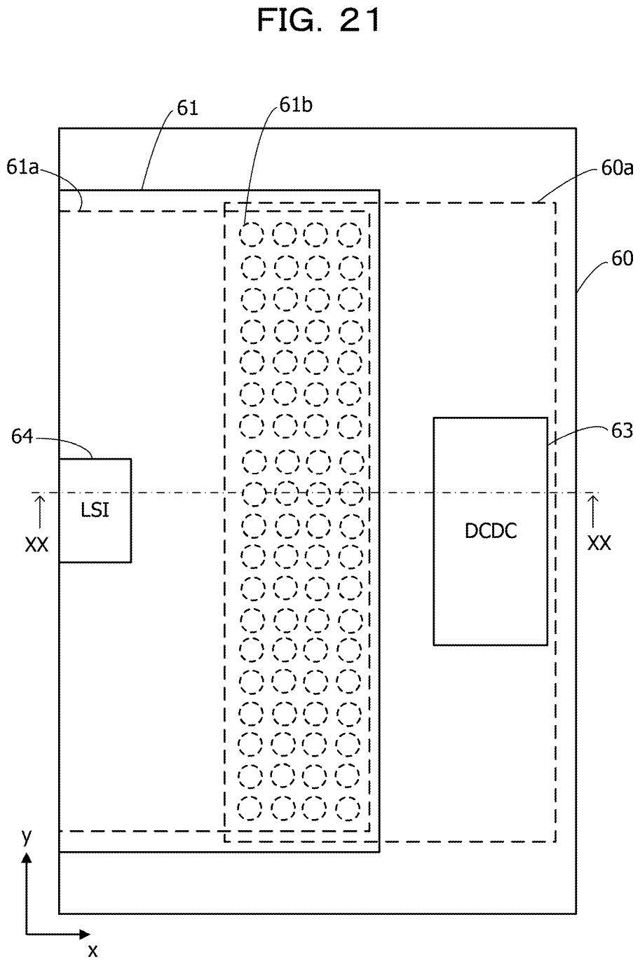

FIG. 20 is a schematic cross-sectional view of the two printed substrates to be designed in the first design example. FIG. 21 is a schematic top view of the two printed substrates to be designed in the second design example. FIG. 20 illustrates a cross section taken along line XX-XX in FIG. 21.

Printed substrates 60 and 61 are coupled via a plurality of power supply terminals or a plurality of ground terminals. In the example of FIG. 20, a plurality of power supply terminals (not illustrated) in each of the printed substrates 60 and 61 are coupled via solder bumps (solder bumps 62a, 62b, 62c, 62d, and the like). A DC-DC converter 63 is mounted on the printed substrate 60, and an LSI 64 is mounted on the printed substrate 61.

FIG. 21 illustrates a region 60a where a power supply wiring layer is formed in the printed substrate 60 and a region 61a where a power supply wiring layer is formed in the printed substrate 61.

A plurality of via coupling portions are provided in the regions 60a and 61a. For example, the via coupling portions 61b provided in the region 61a of the upper printed substrate 61 are electrically coupled to the via coupling portions in the region 60a of the lower printed substrate 60 via power supply terminals and vias.

In a case of designing the printed substrates 60 and 61 as described above, the region division unit 32 determines the current direction, for example, as follows in processing of step S20 in FIG. 5 described above.

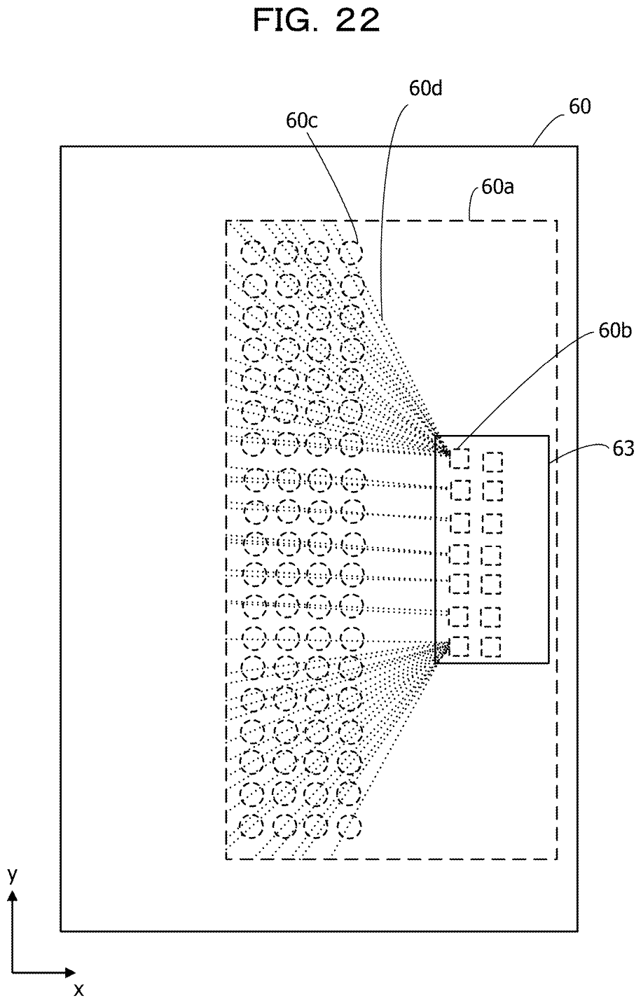

FIG. 22 is a diagram illustrating a determination example of a current direction in the lower printed substrate.

In the region 60a of the lower printed substrate 60, a plurality of via coupling portions (such as via coupling portions 60b) that are located below the DC-DC converter 63 and serve as current supply sources are provided. In the region 60a, a plurality of via coupling portions (such as via coupling portions 60c) that are located below the plurality of power supply terminals coupled to the printed substrate 61 and serve as current supply destinations are provided.

In the example of FIG. 22, the plurality of via coupling portions that serve as current supply destinations are arranged in a wider range than the plurality of via coupling portions that serve as current supply sources. In this case, in the region 60a, the region division unit 32 generates a straight line that passes through each via coupling portion of the supply destination of the power supply current and a via coupling portion of the supply source of the power supply current located at the shortest distance with respect to the via coupling portion. For example, a straight line 60d is a straight line that passes through the via coupling portion 60c of the supply destination of the power supply current and the via coupling portion 60b of the supply source of the power supply current located at the shortest distance to the via coupling portion 60c. The region division unit 32 determines a direction of the straight line generated in the region 60a as the current direction. As illustrated in FIG. 22, a part of the current direction is represented by a plurality of straight lines that radially extend from one via coupling portion (for example, the via coupling portion 60b).

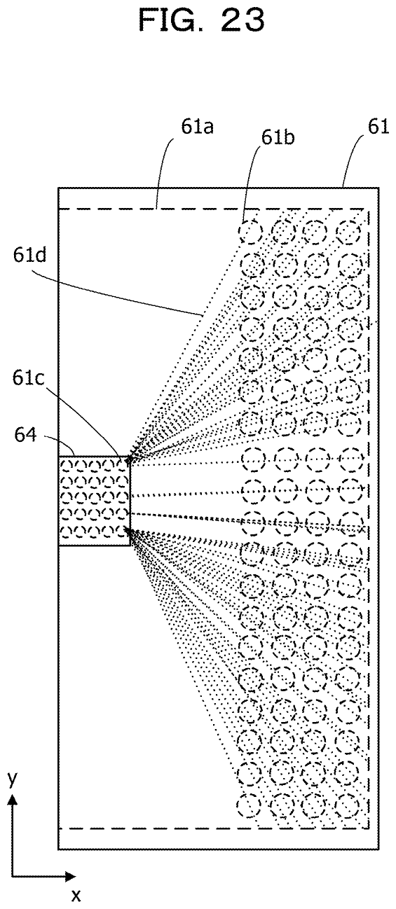

FIG. 23 is a diagram illustrating a determination example of a current direction in the upper printed substrate.

In the region 61a of the upper printed substrate 61, a plurality of via coupling portions (such as the via coupling portions 61b) that are located above the plurality of power supply terminals coupled to the printed substrate 60 and serve as current supply sources are provided. In the region 61a, a plurality of via coupling portions (such as via coupling portions 61c) which are located below the LSI 64 and serve as current supply destinations are provided.

In the region 61a, the region division unit 32 generates a straight line that passes through each via coupling portion of the supply source of the power supply current and a via coupling portion of the supply destination of the power supply current located at the shortest distance with respect to the via coupling portion. For example, the straight line 61d is a straight line that passes through the via coupling portion 61b of the supply source of the power supply current and the via coupling portion 61c of the supply destination of the power supply current located at the shortest distance to the via coupling portion 61b. The region division unit 32 determines a direction of the straight line 61d generated in the region 61a as the current direction. As illustrated in FIG. 23, a part of the current direction is represented by a plurality of straight lines that radially extend from one via coupling portion (for example, the via coupling portion 61c).

Next, the region division unit 32 determines a first region, for example, as follows in the processing of step S21 in FIG. 5 described above.

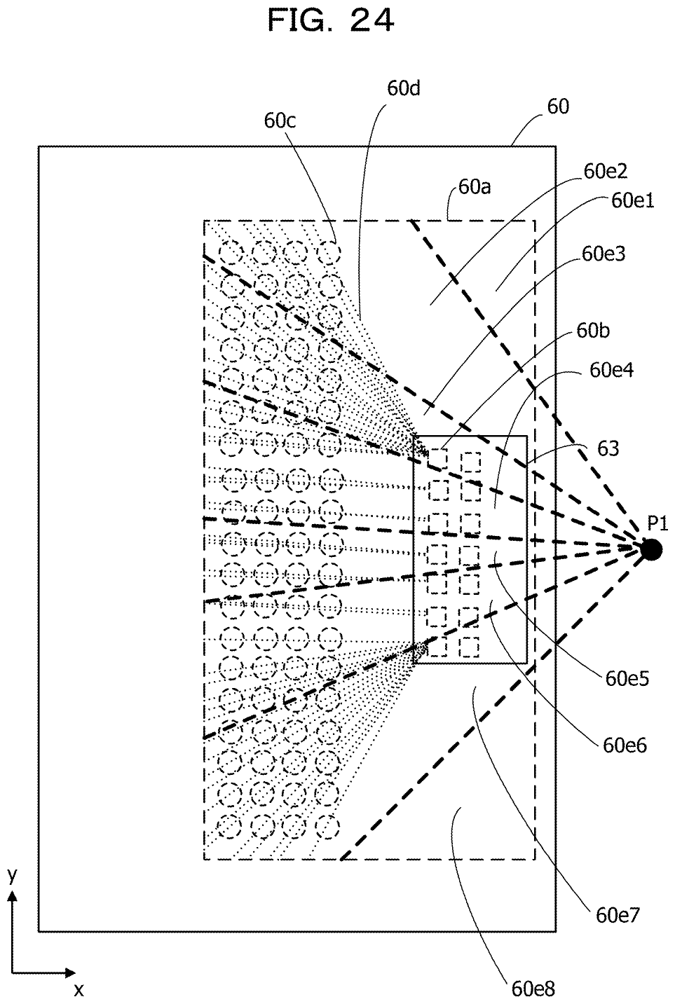

FIG. 24 is a diagram illustrating a determination example of a first region in the lower printed substrate.

The region division unit 32 determines a plurality of first regions by dividing the region 60a of the printed substrate 60 so as not to straddle the generated straight lines (such as the straight lines 60d) as much as possible. In the example of FIG. 24, first regions 60e1, 60e2, 60e3, 60e4, 60e5, 60e6, 60e7, and 60e8 divided by dividing lines that extend in a radiation direction from a certain point P1 are illustrated.

In order to simplify the calculation, it is assumed that there is no inflow or outflow of the power supply current between each of the first regions 60e1 to 60e8.

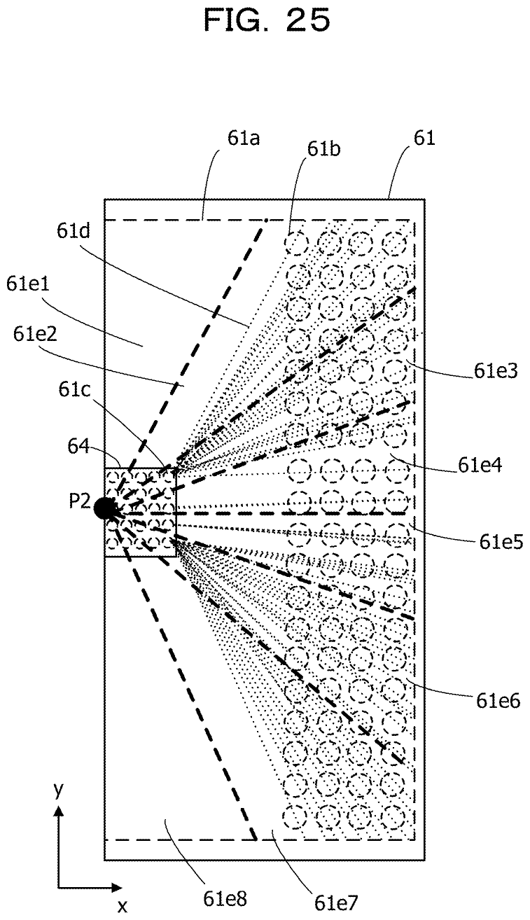

FIG. 25 is a diagram illustrating a determination example of a first region in the upper printed substrate.

The region division unit 32 determines a plurality of first regions by dividing the region 61a of the printed substrate 61 so as not to straddle the generated straight lines (such as the straight lines 61d) as much as possible. In the example of FIG. 25, first regions 61e1, 61e2, 61e3, 61e4, 61e5, 61e6, 61e7, and 61e8 divided by dividing lines that extend in the radiation direction from a certain point P2 are illustrated.

In order to simplify the calculation, it is assumed that there is no inflow or outflow of the power supply current between each of the first regions 61e1 to 61e8.

Next, the region division unit 32 determines the second region in the processing of step S22 in FIG. 5 described above, for example, as follows. The target resistance value calculation unit 33 sets the target voltage drop value in the processing of step S12 in FIG. 4 described above, for example, as follows.

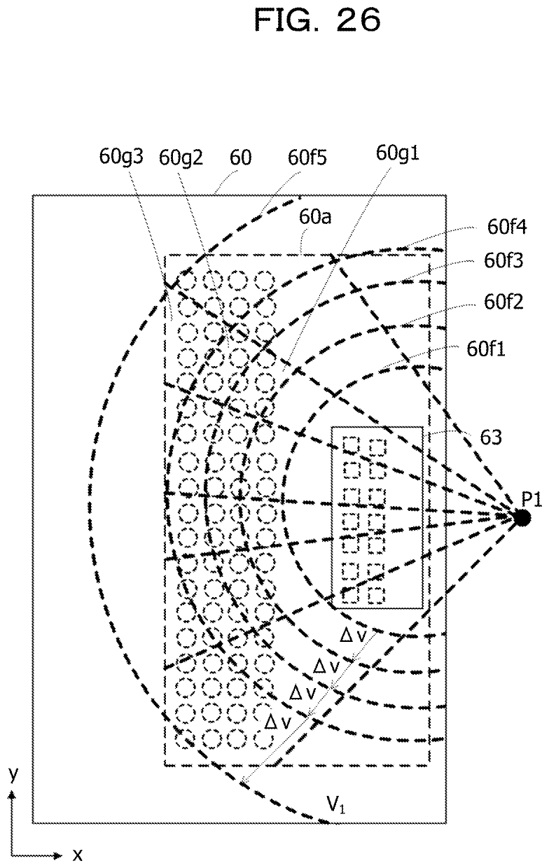

FIG. 26 is a diagram illustrating a determination example of a second region and a setting example of a target voltage drop value in the lower printed substrate.

The region division unit 32 sets equipotential lines 60f1, 60f2, 60f3, 60f4, and 60f5 in the region 60a of the printed substrate 60 and divides the first regions 60e1 to 60e8 illustrated in FIG. 24. The equipotential lines 60f1 to 60f5 perpendicularly intersect boundary lines of the first regions 60e1 to 60e8. Thus, a plurality of second regions (such as second regions 60g1, 60g2, and 60g3) are determined.

After that, the target resistance value calculation unit 33 sets a target voltage drop value between adjacent equipotential lines in the set equipotential lines 60f1 to 60f5. In the example of FIG. 26, it is targeted that a voltage drop from a voltage V₅ to a voltage V₁ occurs between the equipotential line 60f1 to the equipotential line 60f5, and the same target voltage drop value of Δv is set between the adjacent equipotential lines.

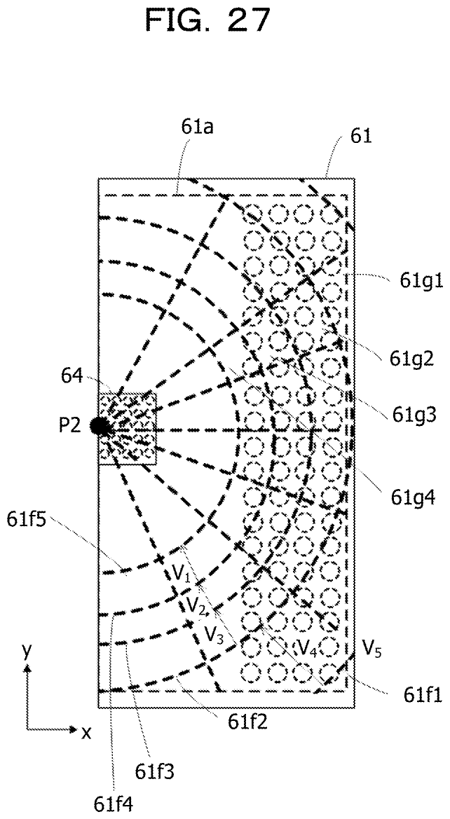

FIG. 27 is a diagram illustrating a determination example of a second region and a setting example of a target voltage drop value in the upper printed substrate.

The region division unit 32 sets equipotential lines 61f1, 61f2, 61f3, 61f4, and 61f5 in the region 61a of the printed substrate 61 and divides the first region 61e1 to 61e8 illustrated in FIG. 25. The equipotential lines 61f1 to 61f5 perpendicularly intersect boundary lines of the first regions 61e1 to 61e8. Thus, a plurality of second regions (such as second regions 61g1, 61g2, 61g3, and 61g4) are determined.

After that, the target resistance value calculation unit 33 sets a target voltage drop value between adjacent equipotential lines in the set plurality of equipotential lines. In the example of FIG. 27, it is targeted that a voltage drop from a voltage V₅ to a voltage V₁ occurs between the equipotential line 61f1 to the equipotential line 61f5, and the same target voltage drop value of Δv is set between the adjacent equipotential lines.

Although the equipotential lines 60f1 to 60f8 and the equipotential lines 61f1 to 61f8 set as illustrated in FIGS. 26 and 27 do not overlap each other unlike the first design example, since the equipotential lines 60f1 to 60f8 and 61f1 to 61f8 are used for setting the target voltage drop value, that is sufficient.

After that, in the processing of steps S13 and S14 in FIG. 4, the target resistance value calculation unit 33 sets the target current value and calculates current values of the respective second regions.

The target resistance value calculation unit 33 sets the same target current value for each of the plurality of power supply terminals that couple the printed substrates 60 and 61. The target current value is, for example, obtained by dividing the current consumption of the LSI 44 by the number of power supply terminals that couple the printed substrates 60 and 61. Hereinafter, it is assumed that the target current value=i.

The target resistance value calculation unit 33 calculates a current value in each second region based on the target current value. As described above, since it is assumed that there is no inflow or outflow of the power supply current between each of the plurality of first regions, the target resistance value calculation unit 33 performs calculation on the assumption that there is no inflow or outflow of the power supply current between the second regions adjacent in a circumferential direction, in each second region. These processes will also be described with reference to FIGS. 26 and 27.

In FIG. 26, a power supply current having a current value represented by the product of the number of included via coupling portions and the target current value=i is drawn from each of the second regions 60g1 to 60g3 including some via coupling portions. In FIG. 27, a power supply current represented by the product of the number of included via coupling portions and the target current value=i is supplied from the printed substrate 60 in each of the second regions 61g1 to 61g3 including some via coupling portions.

Regarding the via coupling portion that straddles the plurality of second regions, which second region the via coupling portion belongs to may be determined according to an area of the included via coupling portion, and the current value may be divided according to an area ratio of the included via coupling portion between the plurality of second regions.

In FIG. 26, in a case where the number of via coupling portions included in each of the second regions 60g1 and 60g2 is four, the current value in the second region 60g3 is calculated as 4i because the power supply current of 4i is drawn from the second region 60g3. The current value in the second region 60g2 is calculated as 8i by adding the power supply current (current value=4i) supplied to the second region 60g3 and the target current value=4i to be drawn. The current value in the second region 60g1 is calculated as 12i by adding the power supply current (current value=8i) supplied to the second region 60g2 and the target current value=4i to be drawn.

In FIG. 27, the number of via coupling portions included in the second region 61g1 is three, the number of via coupling portions included in the second region 61g2 is five, the number of via coupling portions included in the second region 61g3 is two, and the number of via coupling portions included in the second region 61g4 is one. In this case, since the power supply current with the target current value=i is supplied from each of the three via coupling portions, the current value in the second region 61g1 is calculated as 3i. Since the power supply current with the target current value=i is supplied from each of the five via coupling portions and 3i is supplied from the second region 61g1, the current value in the second region 61g2 is calculated as 8i. Since the power supply current with the target current value=i is supplied from each of the two via coupling portions and 8i is supplied from the second region 61g2, the current value in the second region 61g3 is calculated as 10i. Since the power supply current with the target current value=i is supplied from the one via coupling portion and 10i is supplied from the second region 61g3, the current value in the second region 61g4 is calculated as 11i.

Thereafter, the target resistance value calculation unit 33 calculates a target resistance value in the processing of step S15 in FIG. 4, for example, as follows, and the detailed design unit 34 performs detailed design in the processing of step S16 in FIG. 4, for example, as follows. Since these processes are the same as those in the first design example, the description thereof will be omitted.

Also in the second design example as described above, the same effect as that of the first design example may be obtained.

Although the above description relates to the design of the power supply wiring layer, the same design method as described above may be applied to the design of the ground wiring layer.

As described above, the above-described processing contents may be realized, for example, by causing the printed substrate design apparatus 20 which is a computer to execute a program.

The program may be recorded in a computer-readable recording medium (for example, the recording medium 26a). As the recording medium, for example, a magnetic disk, an optical disk, a magneto-optical disk, a semiconductor memory, or the like may be used. The magnetic disk includes an FD and an HDD. The optical disk includes a CD, a CD-recordable (R)/rewritable (RW), a DVD, and a DVD-R/RW. The program may be recorded in a portable recording medium to be distributed. In this case, the program may be copied from the portable recording medium to another recording medium (for example, the HDD 23) to be executed.

Although an aspect of the printed substrate design program, the printed substrate design method, and the printed substrate design apparatus of the present disclosure has been described above based on the embodiments, these are merely examples and are not limited to the above description.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a printed substrate design program for causing a computer to execute a process, the process comprising:
acquiring first design information of a first printed substrate and a second printed substrate coupled to the first printed substrate via a plurality of power supply terminals or a plurality of ground terminals;
for each of the first printed substrate and the second printed substrate,
determining, based on the first design information, a plurality of first regions obtained by dividing a region where a power supply wiring layer or a ground wiring layer is formed along a direction in which a power supply current or a ground current flows, determined from positions of a plurality of supply sources and a plurality of supply destinations of the power supply current or the ground current;
determining a plurality of second regions obtained by dividing the plurality of first regions by a plurality of equipotential lines;
calculating a target resistance value of each of the plurality of second regions based on a target voltage drop value set between adjacent equipotential lines in the plurality of equipotential lines and a target current value set for each of the plurality of power supply terminals or the plurality of ground terminals; and
generating second design information of the power supply wiring layer or the ground wiring layer based on the target resistance value.

2. The recording medium according to claim 1,
wherein the target current value is the same value for each of the plurality of power supply terminals or the plurality of ground terminals.

3. The recording medium according to claim 1,
wherein, in the calculating of the target resistance value, calculation is performed assuming that there is no inflow or outflow of the power supply current or the ground current between the plurality of first regions.

4. The recording medium according to claim 1,
wherein some of the plurality of supply sources and some of the plurality of supply destinations are via coupling portions coupled to some of the plurality of power supply terminals or some of the plurality of ground terminals through vias.

5. The recording medium according to claim 1,
wherein the direction is a direction of first straight lines that couple each of the plurality of supply sources to supply destinations located at a shortest distance with respect to each of the plurality of supply sources among the plurality of supply destinations.

6. The recording medium according to claim 1,
wherein, when the plurality of supply destinations are arranged in a wider range than the plurality of supply sources, the direction is a direction of second straight lines that couple each of the plurality of supply destinations to supply sources located at a shortest distance with respect to each of the plurality of supply destinations among the plurality of supply sources.

7. The recording medium according to claim 1,
wherein the target resistance value is calculated by calculating a current value of each of the plurality of second regions based on the target current value and dividing the target voltage drop value by the calculated current value.

8. The recording medium according to claim 7,
wherein the current value of a certain second region that includes some of the plurality of supply sources among the plurality of second regions is a value obtained by adding a first current value supplied from another second region on an upstream side in the direction and current values of the supply sources included in the certain second region.

9. The recording medium according to claim 7,
wherein the current value of a certain second region including some of the plurality of supply destinations among the plurality of second regions is a value obtained by adding a third current value supplied to another second region on a downstream side in the direction and current values of the supply destinations included in the certain second region.

10. A printed substrate design method performed by a computer, the method comprising:
acquiring first design information of a first printed substrate and a second printed substrate coupled to the first printed substrate via a plurality of power supply terminals or a plurality of ground terminals;
for each of the first printed substrate and the second printed substrate,
determining, based on the first design information, a plurality of first regions obtained by dividing a region where a power supply wiring layer or a ground wiring layer is formed along a direction in which a power supply current or a ground current flows, determined from positions of a plurality of supply sources and a plurality of supply destinations of the power supply current or the ground current;
determining a plurality of second regions obtained by dividing the plurality of first regions by a plurality of equipotential lines;
calculating a target resistance value of each of the plurality of second regions based on a target voltage drop value set between adjacent equipotential lines in the plurality of equipotential lines and a target current value set for each of the plurality of power supply terminals or the plurality of ground terminals; and
generating second design information of the power supply wiring layer or the ground wiring layer based on the target resistance value.

11. A printed substrate design apparatus comprising:
a memory, and
a processor coupled to the memory and configured to:
acquire first design information of a first printed substrate and a second printed substrate coupled to the first printed substrate via a plurality of power supply terminals or a plurality of ground terminals;
for each of the first printed substrate and the second printed substrate,
determine, based on the first design information, a plurality of first regions obtained by dividing a region where a power supply wiring layer or a ground wiring layer is formed along a direction in which a power supply current or a ground current flows, determined from positions of a plurality of supply sources and a plurality of supply destinations of the power supply current or the ground current;
determine a plurality of second regions obtained by dividing the plurality of first regions by a plurality of equipotential lines;
calculate a target resistance value of each of the plurality of second regions based on a target voltage drop value set between adjacent equipotential lines in the plurality of equipotential lines and a target current value set for each of the plurality of power supply terminals or the plurality of ground terminals; and
generate second design information of the power supply wiring layer or the ground wiring layer based on the target resistance value.
